(19) United States
(12) Patent Application Publication
(10) Pub. No.: US 2011/0239270 A1
(43) Pub. Date: Sep. 29, 2011

(54) METHOD AND APPARATUS FOR PROVIDING HETEROGENEOUS SECURITY MANAGEMENT

(75) Inventors: Sampo Juhani Sovio, Riihimaki (FI); Mikko Juhani Terho, Tampere (FI)

(73) Assignee: Nokia Corporation, Espoo (FI)

(21) Appl. No.: 13/072,140

(22) Filed: Mar. 25, 2011

Related U.S. Application Data
(60) Provisional application No. 61/318,013, filed on Mar. 26, 2010.

(51) Int. Cl. G06F 21/00

(52) U.S. Cl. 726/1; 726/3

(57) ABSTRACT

An approach is provided for providing a heterogeneous security management platform to combine or integrate different applications employing different security requirements. An interface acts on a request that references, at least in part, a resource, the resource associated with a network identifier. The interface determines whether the network identifier is listed in a secure phonebook. The secure phonebook associates the network identifier with, at least in part, a security context. The interface provides the security context for one or more applications, scripts, executables, or combination thereof to determine access privileges to the resource based, at least in part, on the determination.

### RELATED APPLICATIONS

This application claims the benefit of the earlier filing date under 35 U.S.C. §119(e) of U.S. Provisional Application Ser. No. 61/318,013 filed Mar. 26, 2010, entitled “Method and Apparatus for Providing Heterogeneous Security Management,” the entirety of which is incorporated herein by reference.

### BACKGROUND

Network service providers and device manufacturers are continually challenged to deliver value, convenience, and security to consumers by, for example, providing compelling network services. As a result, the number and variety of both native and web-based applications and services provided to users and consumers are continually growing. Combination or integration of one or more of these applications to provide new services or more convenient access to the applications is a challenging matter. These applications and services can have different security requirements and/or different access policies. Moreover, the historic lack of a client-side security mechanism for integrating these applications and services limits their combination or integration. Traditionally, access to applications or services between different domains to, for instance, combine or integrate services, functions, content, or other network resources is limited, therefore, resulting in technical burdens to providing access to such applications.

### SOME EXAMPLE EMBODIMENTS

Therefore, there is a need for an approach for providing a security management platform to combine or integrate different applications and services employing heterogeneous or different security requirements.

According to one embodiment, a method comprises acting on a request that references, at least in part, a resource, the resource associated with a network identifier. The method also comprises determining whether the network identifier is listed in a secure phonebook. The secure phonebook associates the network identifier with, at least in part, a security context. The method further comprises providing the security context for one or more applications, scripts, executables, or combination thereof to determine access privileges to the resource based, at least in part, on the determination.

According to another embodiment, an apparatus comprising at least one processor, and at least one memory including computer program code, the at least one memory and the computer program code configured to, with the at least one processor, cause, at least in part, the apparatus to act on a request that references, at least in part, a resource, the resource associated with a network identifier. The apparatus is also caused to determine whether the network identifier is listed in a secure phonebook. The secure phonebook associates the network identifier with, at least in part, a security context. The apparatus is further caused to provide the security context for one or more applications, scripts, executables, or combination thereof to determine access privileges to the resource based, at least in part, on the determination.

According to another embodiment, a computer-readable storage medium carrying one or more sequences of one or more instructions which, when executed by one or more processors, cause, at least in part, an apparatus to act on a request that references, at least in part, a resource, the resource associated with a network identifier. The apparatus is also caused to determine whether the network identifier is listed in a secure phonebook. The secure phonebook associates the network identifier with, at least in part, a security context. The apparatus is further caused to provide the security context for one or more applications, scripts, executables, or combination thereof to determine access privileges to the resource based, at least in part, on the determination.

According to another embodiment, an apparatus comprises means for acting on a request that references, at least in part, a resource, the resource associated with a network identifier. The apparatus also comprises means for determining whether the network identifier is listed in a secure phonebook. The secure phonebook associates the network identifier with, at least in part, a security context. The apparatus further comprises means for providing the security context for one or more applications, scripts, executables, or combination thereof to determine access privileges to the resource based, at least in part, on the determination.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are diagrams of a system capable of providing a heterogeneous security management platform, according to various embodiments;

FIG. 2 is a diagram of the components of a security manager, according to one embodiment;

FIGS. 3A and 3B are flowcharts of processes for providing a security management platform, according to various embodiments;

FIG. 4 is a flowchart of a process for creating entries in a secure phonebook, according to one embodiment;

FIG. 5 is a flowchart of a process for managing security information for entries in a secure phonebook, according to one embodiment;

FIG. 6 is a flowchart of a process for managing security information for entries in a secure phonebook with common components, according to one embodiment;

FIGS. 7A and 7B are diagrams of a graphical user interface for managing security information for entries in a secure phonebook, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing heterogeneous security management are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “network resource” refers to any application, entity, service, content, data structure, and/or communication link available through connection to a network. Also, as used herein, the term “authentication context” can include: (1) information regarding initial identification mechanisms of a user, client, customer, etc.; (2) information regarding authentication mechanism or method (e.g., passwords, one time password, a cookie, a limited use key, a secret key, a consumer key, an access token, etc.); (3) information regarding storage and protection of credential (e.g., password rules, smart carts, etc.); and the like.

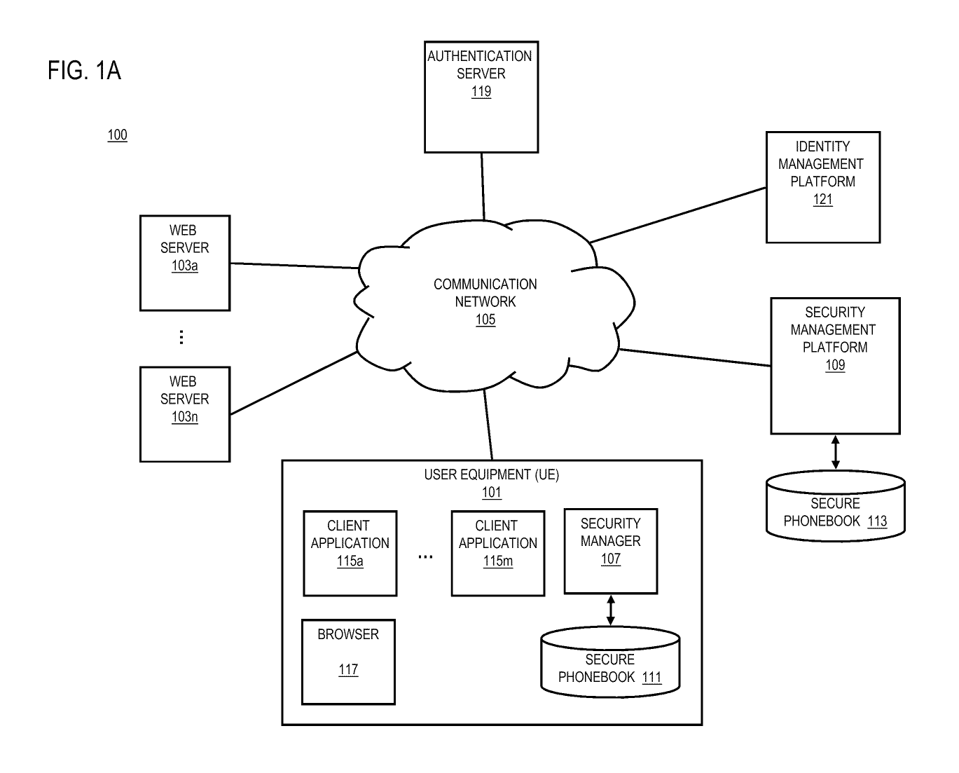

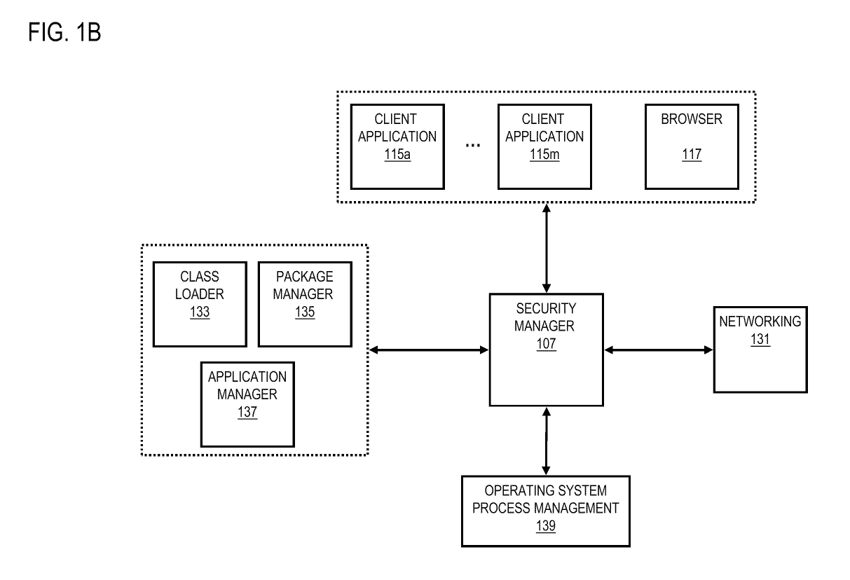

FIG. 1A is a diagram of a system capable of providing a heterogeneous security management platform, according to one embodiment. Applications (such as, but not limited to, applications executing in run-time environments (e.g., Java runtime, Web runtime, etc.), browsers, etc.) can be executed on user devices to enable access to services provided by application servers, web servers, etc. As previously noted, the number and variety of these client applications are continually increasing; and security and convenience of access to the application servers, web server, etc. through the client applications, browsers, etc., are important challenges facing service providers. Also, the need to combine or integrate services and functions provided by the applications servers and web servers while employing their security requirements is growing. Traditionally, access to integration of applications, services, contents, etc. provided by the application servers and web servers is limited due to application of a common security context. In other words, in a traditional application environment, all applications (e.g., a browser application) enforce the same security policies and limitations. By way of example, on example of such a policy or limitation is the “same origin policy” which generally permits access to a combination of services or applications only if they originate from a same domain. For instance, the same origin policy, employed by the web browsers, limits scripts (e.g., such as scripts written in asynchronous JavaScript and Extensible Markup Language) embedded in web page's source code to access functions, services, contents, and/or applications of web servers and/or application servers that are not in the domain of the script. The same origin policy is the common security measure used in order to partition between application servers that may use different security policies and/or requirements. However, the same origin policy makes it difficult for service providers to provide services that can combine or integrate functions from application servers that employ different security policies or refer to resources in different domains.

In certain embodiments, the term domain is an identification label associated with a realm of administrative autonomy, authority, or control in the internet. Further, the domain may include a top-level domain such as *.com, *.net, *.org, etc. as well as second-level (e.g., a root website name) and third-level domain names (e.g., modifier.[root]). The term “origin” in the concept of same origin policy may be defined using the domain name, application layer protocol, and (in browsers) Transmission Control Protocol (TCP) port of the Hyper Text Markup Language (HTML) document running a script. Two resources can be considered to be of the same origin if some or all of these values are similar. The policy can permit scripts running on pages originating from the same site to access each other's methods and properties with no specific restrictions—but prevents access to most methods and properties across pages on different sites. Many browsers limit concurrent connections to address security flaws on the whole set up. In the current systems the security contexts and/or security policy for browsers are one-instance operating system permissions, which do not allow variance in permissions.

To address these problems, a system 100 of FIG. 1A can advantageously provide a heterogeneous security management platform to combine or integrate functions, services, applications, and/or contents of application servers and/or web servers that may employ different security policies. More specifically, the system 100 can provide and enforce different or heterogeneous security policies or contexts for each application or service executing within a single environment (e.g., a single device). In this way, the system 100 advantageously enables changes in permissions and security information when domain of resources of the system 100 changes. According to an embodiment of FIG. 1, a user equipment (UE) 101 can communicate with multiple network resources, including web servers 103a-130n (collectively referenced hereinafter as web servers 103), through, for example, communication network 105. In one example, security manager 107 and/or security management platform 109 can be used to identify and employ security requirements, contexts, policies or combination thereof used for the web servers 103 and/or the UE 101. Use of the security manager 107 and/or the security management platform 109 can advantageously unify identification and security management for local and network resources.

It is contemplated that the security management as disclosed in the embodiments can be performed by the security manager 107, the security management platform 109, or a combination thereof. Also, it is noted that the security management of the security manager 107, the security management platform 109, or a combination thereof can be performed locally and/or can be performed as a distributed platform.

According to an embodiment, some or all of the resources of the system 100 of FIG. 1A are associated with network identifiers. In one example, the network identifiers, which can include Uniform Resource Identifier (URI), Uniform Resource Locator (URL), fully qualified domain name (FQDN), etc., can be used to specify identified resources and mechanisms for accessing or retrieving them. In this example, network identifiers for resources can be used to unify identification and security management for local and network resources. In one example, the identity management platform 121 can combine a dynamic domain name service (DNS) and device identity service to provide identifiers for resources in the system 100. According to certain embodiments, the network identifiers associated with the resources can be signed and certified by, for example, a service provider to ensure security of services. In the exemplary system 100, for illustration purposes, the authentication server 119 can communicate with the identity management platform 121 to apply authentication information to the network identifiers. In one example, the authentication server 119 can implement a public key infrastructure (PKI) to generate signed and certified network identifiers.

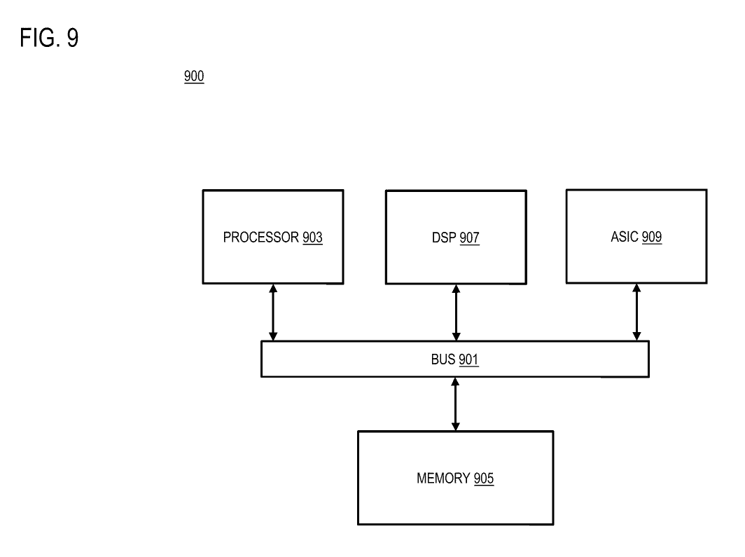

According to certain embodiments, the security manager 107 and/or the security management platform 109, which may be implemented in a chip set as shown in FIG. 9 and described below, with or without one or more computer program instructions. Additionally, the security manager 107 and/or the security management platform 109 can include direct connectivity to a secure phonebook 113 and/or access a secure phonebook 111 in the UE 101 over the communication network 105. In one example, the secure phonebook 111 and/or 113 can include the network identifiers associated with the resources of the system 100 and security information, such as security context, policy, etc., associated to the network identifier. In other, the secure phonebook 111 or 113 provides a directory of network resources available in any number of domains along with the corresponding security policies or contexts that should be applied when those network resources are accessed. Additionally, the secure phonebook can include information associated to users, services, devices, and/or any other network addressable component resident in the UE 101 or other UEs 101 or otherwise accessible over the communication network 105. In one embodiment, the security information in the secure phonebook 111 can provide information for applications, scripts, executables, etc. to access resources of the system 100. According to one example, the security information associated to different resources can be similar, different, or unique to the resource. In addition, the security information may include resource authentication tokens or information for creating the tokens. These tokens can, for instance, be used for authenticated access to corresponding resource. Alternatively or additionally, default security information can be defined for one or more resources. In one example, the security information can be generated and/or updated by permitted resources or users.

According to an embodiment, the security manager 107 (and/or the security management platform 109) may communicate with operating system, operating system management, networking daemon, browser, client applications, class loader, package manager, application manager, etc., as explained in more detail with respect to FIG. 1B. The security manager 107 can receive and/or intercept access requests generated from resources in system 100. The security manager 107 can then act on those requests to determine the security information (such as security context, security policy, etc.) associated with the originating resource and/or destination resource as specified in the secure phonebook 111. The security manager 107 can enforce or otherwise apply the determined security information (e.g., security context or policy) to the respective resources in order to determine their privileges and policies. Therefore, the security manager 107 is able to determine changes in network identifiers and, using the secure phonebook, map the identifiers to security information to determine access privileges for corresponding applications, scripts, executables, etc. In one embodiment, the access privileges may specify access to any resource addressable via the network identifier including, for instance, functional hardware components (e.g., camera module, location sensors, fingerprint scanner, etc.) and software components (e.g., contact list, files on the device, interfaces to other applications, etc.) of the UE 101. According to an example, an authorized user, such as a user of UE 101, can modify and edit the security information (such as security policy) associated to network identifiers stored in the secure phonebook. Additionally or alternatively, authorized resources (e.g., service providers, content providers, network operators, etc.) can add and/or update security information.

According to certain embodiments, the UE 101 can include client applications 115a-115m (collectively referenced hereinafter as client applications 115) and the browser 117 to, for instance, access the web server 103. The client applications 115 and/or the browser 117 can initiate transmission of an access request for access to the web servers 103. For example, the browser 117 can request access to the web server 103a using a bookmark, a URL, an HTML code, a script, a plug-in, etc. In this example, the security manager 107 can intercept the access request from the browser 117. According to an embodiment, the security manager 107 can determine the network identifier associated to the browser 117 and the network identifier associated to the web server 103a. In one example, the network identifier associated to the browser 117 can include the fully qualified domain name (FQDN) which can include the browser's bookmark's first bits. The security manager 107 can further determine, using the secure phonebook 111, security information associated with the web server 103a using, for instance, its network identifier. Additionally, the security manager 107 can implement the security information associated with the web server 103a. According to an embodiment, the security information (such as security context, security policy, etc.) associated with the web server 103a can include access privileges that the web server 103a and/or the browser 117 can have to access resources in the system 100. For example, the security information associated with the web server 103a can indicate that the web server 103a and/or the browser 117 have privileges to access to, for instance, web server 103n that does not belong to the same domain as the web server 103a. According to another example, the security information can indicate that the web server 103a and/or the browser 117 have access privileges to access resources on the UE 101, such as the operating system, networking daemon, a camera of the UE 101, etc. Therefore, the use of the security manager 107 with the secure phonebook 111 (and/or the security management platform 109 and the secure phonebook 113) can advantageously enable use of dynamic change of security information for resources in system 100.

Continuing with this example, if the browser 117, using a different bookmark, URL, etc., initiates another request to access another web server, for instance, web server 103b, the security manager 107 receives and/or intercepts the request and determines the security information associated with the browser 117 and/or the web server 103b. According to one embodiment, the security manager 107 implements the security information based on the determination. Alternatively or additionally, if the security information is similar to the security information previously implemented, no change is implemented in the security configuration. In this way, the security manager 107 enables the browser 117 to combine or “mash-up” content available from any number of different domains for presentation in a single page or session of the browser 117. More specifically, the mash-up or combination may provide for creation of any arbitrary amount of Internet connections to the resources. Moreover, each resource may be associated with a resource authentication token to specify and/or authorize access (e.g., via application programming interfaces (APIs)) to the resource. In one example, the mash-up content includes scripts (e.g., JavaScript) or other executables for accessing the resources, wherein the scripts or executables maybe are provided access rights to the resources based on the security information.

As discussed, when the security manager 107 intercepts the access request from the client applications 115, the browser 117, the web servers 103, or combination thereof, the security manager 107 acts on the request to determine whether a network identifier associated with the requestor exists in the secure phonebook 111. If the network identifier (e.g., a URL) exists in the phonebook 111, the security manager 107 retrieves security information associated with the identifier. However, if no security information is available associated with the identifier, according to one embodiment, the security manager 107 can implement a default security context for the requestor. In one example, the default security information can include the same origin policy.

According to certain embodiments, the security information associated with resources that are stored in, for instance, the secure phonebook 111 and are accessible by the security manager 107 can include authentication information associated with users, applications, resources, etc. In one example, the authentication information can include information regarding public keys and certificates that can, for instance, be used in Public Key Infrastructure (PKI). However, it is contemplated that other methods and policies for authentication can be used. According to one example, other UEs 101 (not shown) can access the resources available on the UE 101, if they are authorized. In one embodiment, when a user equipment (not shown) attempts to access to the resources of the UE 101, the access request is intercepted by the security manager 107. In one example, the security manager 107 determines whether authentication and/or security information for the requesting user equipment and/or a user of the requesting user equipment is available in the secure phonebook 111. If it is determined that authentication information for the requesting user equipment and/or its user is not available, the security manager 107 initiates an authentication process to authenticate the requesting user equipment or its user. In one example, the security manager 107 can utilize the authentication server 119 for authentication purposes. In this example, the security manager 107 can initiate a request to the authentication server 119 to authenticate the requesting user equipment and/or its user and receive authentication information regarding the requesting user equipment and/or its user from the authentication server 119. The security manager 107 can store the authentication information along with other security information for the requesting user equipment and/or its user.

Therefore, if a subsequent request is received from the requesting user equipment and/or its user to access the resources of the UE 101, the requesting user equipment and/or its user, the security manager 107 can use the authentication information to authenticate the requesting user equipment and/or its user. The security manager 107 can further utilize the security information to determine, for instance, access privileges of the requesting user equipment and/or its user. Therefore, the security manager 107, along with the secure phonebook 111, can advantageously manage peer-to-peer sessions between users, consumers, UEs 101, etc. In one example, the peer-to-peer sessions managed by the security manager can be used to establish, for instance, a club between selected users, consumers, members of owners of specific UEs 101, etc., who can have the ability to run peer-to-peer applications, servers, etc., between, for example, friends, social networks, etc. Further, the security manager 107 and/or the security management platform 109 in connection with the secure phonebooks 111 and/or 113 can advantageously control unwanted traffic, such as spam, telemarketing, etc., to, for example, the UE 101.

According to another example, the security manager 107 along with the phonebook 111 can advantageously manage inheritance of security policies. In this embodiment, security information stored in the secure phonebook 111 can specify, for instance, security policies associated with one or more components of a resource, service, entity, etc., for instance, service 1. Also, service 1 may have one or more components in common with another resource, service, entity, etc., for instance, service 2. The security manager 107 can advantageously detect any changes that might occur in the one or more common components due to any changes to, for example, service A, and automatically or by prompting the user of UE 101 can direct the change to, for example, service B. According to this embodiment, if security information associated with one or more components of service A is changed, the security manager 107 is able to detect the changes. Further, the security manager 107 can determine other resources, entities, service, etc., for example, service B, which may have common components with service A. Continuing with this example, in one case, the security manager 107 an initiate a presentation of a prompt to the user of the UE 101 to determine whether these changes (e.g., changes to the security information of at least one component of service A) should be applied to all the components of service A. Further, the security manager 107 can prompt the user of UE 101 to determine whether these changes should also to be directed to the security information of other resources, entities, services, etc., such as service B, which have common components with service A. The security manager 107 can receive a response to the prompt and act accordingly. In one example, based on the user's response, the security manager 107 can update the security information of the service B based on the changes to the one or more common components. Additionally or alternatively, the security manager 107 can automatically update the security information of service B without first contacting or prompting the user of the UE 101. According to another embodiment, access or changes to components of service B may be limited only to those components accessible by or in common with service A.

According to another embodiment, the security management can also be performed by the security management platform 109 and the secure phonebook 113 in addition to and/or instead of the security manager 107 and the secure phonebook 111. In this example, security information stored in the secure phonebook 113 can include signed resource tokens that can, for example, specify security policy and security context for access to resources in system 100, such as resources in and/or related to the UE 101 and/or the user of the UE 101. For example, the security management platform 109 along with the secure phonebook 113 can advantageously manage access to applications, contents, information, etc., related to UE 101 and/or the user of UE 101 that exist in system 100, for instance, outside the UE 101. In this example, the user of the UE 101 can be able to determine one or more applications, users, etc., which can have access to applications, contents, information, etc., related to UE 101 and/or the user of UE 101. In one embodiment, the user of the UE 101 can generate and/or update a list of applications, users, etc., which can access applications, contents, information, etc., related to UE 101 and/or the user of UE 101. In this example, the user of the UE 101 can access the security management platform 109 and/or secure phonebook 113 to update the list of authorized applications, users, etc. Alternatively or additionally, the security manager 107 can be used to update or create the resource token that includes the authorized list information. In one embodiment, the resource token can be signed and certified by the user's authentication information, by a service server's authentication information, etc., before being stored in the phonebook 113. Additionally or alternatively, the security manager 107 and/or the security management platform 109 can verify the signature and/or the certificate associated with the resource token, using, for example, the authentication server 119. If verified, the resource token is stored in the secure phonebook 113.

Therefore, if an application, a user, etc. requests to access applications, contents, information, etc., related to UE 101 and/or the user of UE 101, the security management platform 109 (and/or security manager 107) can intercept the access request, determine the resource token, examine the resource token, and determine whether the requestor has permission to access the applications, contents, information, etc., related to UE 101 and/or the user of UE 101. The access will be granted if the access token allows the access.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, the web servers 103a-103n, the security management platform 109, the authentication server 119, and the identity management platform 121, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the security manager 107 and the security management platform 109 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 1B is a diagram of a system capable of providing a security management platform, according to another embodiment. More specifically, FIG. 1B illustrates the relationships among components of the UE 101 and the security manager 107. According to one embodiment, the security manager 107 can be in communication with networking daemon 131 and/or a local firewall (not shown) in the UE 101. In one example, the networking daemon 131 is an interface between the UE 101 and the communication network 105 of system 100 of FIG. 1A. In one example, asynchronous incoming networking and telecommunication events are received by the networking daemon 131 and are intercepted by the security manager 107 to determine appropriate security information (such as security context, security policy, etc.) for these events. In one example, the security manager 107 determines the identifier associated to these events, determines the security information based on the identifier, and implements the security information. In an embodiment, the security manager 107 initiates a new process with, for instance, the privileges indicated by the security information. In one example, if the incoming events represent a “Blocked” value, which may cause no action or specific action into the local firewall (not shown), no access and no new process is initiated. According to another embodiment, the security manager 107 can be alerted if networking addresses are changed inside a process and/or domain name of an identifier cannot be determined. Therefore, the security manager 107 can advantageously allow different connections that might employ different security requirements that are determined to be “safe” and/or “non-blocked”. Also, according to certain embodiments, the security manager 107 may divide the incoming networking events and/or requests to one or more classes and, depending on the origin of the events and/or requests and/or the requested resources, apply different security contexts and/or policies.

According to certain embodiment, the UE 101 can include a class loader 133 for, e.g., scripts; a package manager 135 for, e.g., plug-ins and libraries; and an application manager 137 for, e.g., installable applications. In one example, actions of the class loader 133, package manager 135, and the application manager 137 are confirmed with the security manager 107. For example, if the application manager 137 is used to install an application on, for example, the UE 101, a new entry is generated for the new application in the secure phonebook 111 associating an identifier (e.g., URL or other FQDN) of the installed application and/or an identifier of a source of the application with security information related to it. Additionally or alternatively, if application manager 137 updates a previously installed application, the security manager 107 can retrieve the security information associated to that application and determine whether there is a need to update the security information. In one example, if the source of the application is associated to a “Signed software system management” policy (as explained in more details later), the privileges associated with the application can be high. According to another example, the security manager 107 can use default security information for an installed application if no security is indicated. Similar operations and interactions between class loader 133, package manager 135, and the security manager 107 can be considered. In one example, the package manager can operate in a permissive mode, where majority of its operations are invisible, however, entries will be made to the secure phonebook 111 through the security manager 107. According to certain embodiment, the class loader 133 can be integrated in the package manager 135.

According to another embodiment, the security manager 107 can be in communication with the operating system process management 139. Operations where the operating system starts a process is verified and authorized by the security manager 107. In an example, the underlying operating environment can support number of different access categories and access right, therefore, the security manager 107 and the secure phonebook 111 can support arbitrary number of security policies and/or security contexts. Below is an exemplary list of some security policies that can be used in accordance with the security manager 107 and the secure phonebook 111.

“Signed system software management service”, policy is defined by unique rights are to update the security system and the reference to system software repository URL in the secure phonebook.

“Standard application”, policy is the standard user or operating system defined values given for application downloaded from the network or an application store.

“Standard plug-in”, policy is the standard user or operating system defined value for browser plug-ins.

“Signed name and identity service”, policy is defined by unique rights to create, update and revoke the signed Domain Name System (DNS) name used for the local host and associated mapping to user of the device and his identity, including the pseudo signed URL used to specify the user identity.

“Signed contact database back-up service”, policy is defined by unique right to start application to create, update, modify, copy, rewrite and delete the secure phonebook contains all known URL's to the system. According to an embodiment, system 100 of FIG. 1A can be configured to provide back-up services for contents of the secure phonebook 111 and/or 113. In one example, the back-up service provided by system 100 can protect the user of the UE 101 against any possible accidents that may occur for the UE 101. Alternatively or additionally, the back-up service can also be advantageous if a user and/or a consumer possess more than one user equipment. Therefore, contents and entries of secure phonebook 111 of different user devices can be stored and synchronized. According to one example, the backed-up secure phonebook of the UE 101 can be stored at a service provider server and/or other places in the network in a centralized or distributed manner and can be controlled based on the “Signed contact database back-up service”. In one example, if the UE 101 desires to restore the backed-up secure phonebook using the back-up service, the credentials of the user of the UE 101 is validated (e.g., using the authentication server 119 of FIG. 1A) before the secure phonebook is restored. Additionally or alternatively, the UE 101 can include a service provider services master key, and this key is validated by the service provider before the secure phonebook is restored. In one example, a device embedded software control key can also exit that is derived from the service provider services master key and can be used to validate integrity of services.
“Signed services”, policy is defined so that the system tries automatically log in into service with signed user identity eliminating the need for user name and password.
“Signed friend”, policy is defined so that first time communication attempt form a potential friend goes to knocking procedure, if receiving party accepts the invitation an signed URL entry is created into the secure phonebook having status of “Signed friend”. For consumer convenience it is recommended that this policy is symmetrical and not very granular.
“Signed non-friend”, policy is defined so that knocking procedure is repeated for the next incoming asynchronous networking connection.
“Signed blocked”, policy is defined so that local firewall block access by this signed URL. Similar firewall control and policies may be applied also for non-signed URL's depending on operating system security support.
“Same origin policy”, is the default access rights used by commercial browser application, traditionally not having access to all Application Programming Interfaces (APIs) available to local applications.
“Full user access”, policy is generally defined so that all Internet applications and local applications can access all non-privileged operations. Privileged operations are only the operations that compromise the “Signed system software management service” and “Signed name and identity service”.

According to an embodiment, the security manager 107 along with the secure phonebook 111 can include at least one or more of the above-noted policies. Additionally or alternatively, these policies can further be updated, removed, renamed, sub-classed, etc., by, for example, a user of the UE 101. In one example, the security manager 107 and the secure phonebook 111 can support unlimited number of security policies and/or security contexts.

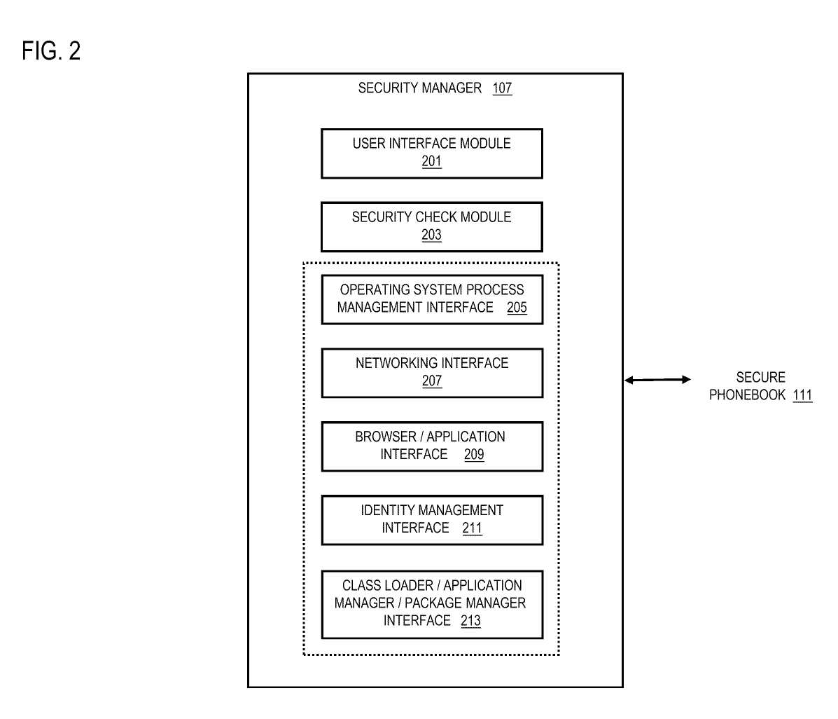

FIG. 2 is a diagram of the components of a security manager, according to one embodiment. By way of example, the security manager 107 can include one or more components for providing a platform to combine or integrate different applications employing different security requirements. It is contemplated that the functions of these components may be combined in one or more components or performed by other components of equivalent functionality. Although FIG. 2 illustrates component of a security manager 107, however, it is contemplated that the security management platform 109, which can perform similar functions to the security manager 107, can include similar components. Also, it is noted that the components can be operate in a distribute manner.

In this embodiment, the security manager 107 can include a user interface module 201. In one example, the user interface module 201 can be invoked to launch a user interface (UI). The UI controlled by the user interface module 201, can be used as the interface between, for example, a user of the UE 101 and the security manager 107 and/or the secure phonebook 111. In one embodiment, the user of the UE 101 can use the UI to add, delete, update, etc., the contents and entries of the secure phonebook 111. In one embodiment, the user can associate previous entries of the phonebook 111 when she/he is adding or updating the entry. This can be the case in an embodiment where a phonebook entry specifies a URL of the resource and set of URL's that can access to that resource. The set of URL's that can access to the resource can be extended by selecting set of URL's from the contact list extracted from secure phonebook 111. The UI launched by the user interface module 201, can be used by the user of the UE 101 to manage resources, their identifier, and/or their security information. In one example, the security manager 107 can define access privileges that the user has to manage the contents and entries of the secure phonebook 111.

By way of example, the security manager 107 can include a security check module 203 and the interfaces including the operating system process management interface 205, the networking interface 207, the browser/application interface 209, the identity management interface 211, and class loader/application manager/package manager interface 213 to interface with different components of the UE 101 and/or the system 100 and to validate and employ necessary security policies. According to an example, the security check module 203 can receive and/or intercept a request to access one or more resources of the UE 101 or the system 100 of FIG. 1A through, for example, the interfaces 205, 207, 209, 211, and 213. In one example, the security check module 203 can determine a network identifier of the entity (such as a resource, a user equipment, an application, etc.) requesting access and/or identifier associated with the requested resources.

Further, the security check module 203, in communication with the secure phonebook 111 can determine if any security information for the identifier(s) exists. If no security information is available, the security check module 203 can implement and provide a default security context and/or policy, for example, same origin policy. However, if security information is available for the requested resources and/or the requesting entity, the security check module 203 can implement and provide the determined security policy and/or context. In one example, resource tokens can be available for the requested resources can have in the secure phonebook 111, which can determine if the requested entity has privileges to access the resources. According to another example, the secure check module can intercept an access request from a browser (such as browser 117 of FIGS. 1A and 1B), for example, from a script associated with the browser, to access web servers 103a and 103b of FIG. 1A. The security check module 203 can determine, for example, privileges of the browser to access the web servers, in a case the web servers belong to different domains.

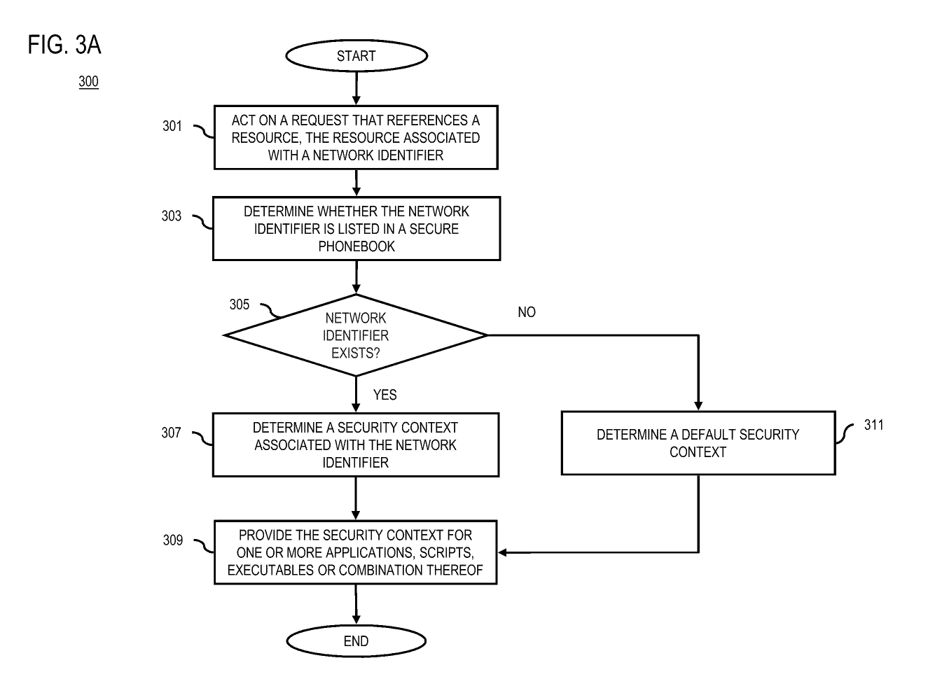

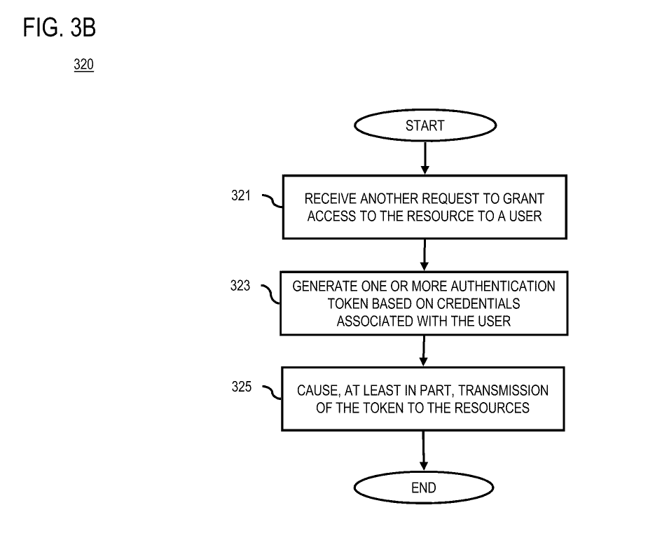

FIGS. 3A and 3B are flowcharts of processes for providing a security management platform, according to various embodiments. In one embodiment, the security manager 107 and/or the security management platform 109 of FIG. 1A performs the processes 300 and/or 320 and is implemented in, for instance, a chip set including a processor and a memory as shown in FIG. 9.

In step 301, a request that references a resource is received and/or intercepted and is acted on. As discussed, in one embodiment, the request can be initiated by one or more entities, such as a resource, a user equipment, an application, a script, an executable, etc., that might operate from the UE 101 of FIG. 1A or anywhere in the system 100 of FIG. 1A. Also, according to one embodiment, the resource referenced in the request can be a resource operating from the UE 101 of FIG. 1A or anywhere in the system 100 of FIG. 1A. In one example, the referenced resource is associated with a network identifier, and in step 301, according to an embodiment, the network identifier of the referenced resource can be determined. In an example, the network identifier can be included in the request. Alternatively or additionally, a database such as a look up table can be used to determine the network identifier of the referenced resource.

In step 303, it is determined whether the network identifier exists in the secure phonebook 111. For instance, the existence of the network identifier of the references resource can be checked in the secure phonebook 111 and/or the secure phonebook 113. In step 305, a decision is made whether the network identifier exists in the secure phonebook. The process 300 continues in step 307 if the secure phonebook (for instance secure phonebook 111) includes an entry for the network identifier of the referenced resource. Based on the entry located in the secure phonebook, in step 307, security information associated with the resource is determined. In one example, the security information can include a security context and/or a security policy. According to an embodiment, the security context can determine access privileges to access the resource.

In step 309, the determined security information is provided to one or more entities (such as resources, users, applications, scripts, executables, etc.) that, for example, requested access to the resource. In on embodiment, step 309 can include providing the security context and/or enforcing the security policy. For example, in step 309, it is determined whether the requesting entities have sufficient access privileges based, at least in part, on the determined security context. Access to the resource can be granted if the requesting entities have sufficient privileges.

According to certain embodiments, if the determination in steps 303 and 305 decides that the network identifier associated to the references resource is not available in the secure phonebook, therefore, it can be decided that no security information is available for the resource. According to an embodiment, in this case, the process 300 can continue to step 311. In step 311, default security information can be determined for the resource and the default security information can be enforced in step 309. As discussed, in one example, the default security information can include the same origin policy.

FIG. 3B illustrates an exemplary process 320 that advantageously expedites access to resources, according to an exemplary embodiment. In one example, the process 320 can be performed by the security management platform 109 and/or the security manager 107 of FIG. 1A. According to certain embodiments, in step 321, a request initiated by one or more users to access a resource is received. In one example, the requested resource can be a resource operating in the UE 101 and/or anywhere in system 100 of FIG. 1A. In step 323, an authentication token can be generated for each of the requesting users based, at least in part, on the credentials of the users. In one example, the access request can include the credentials associated to the requesting users and the authentication tokens can be generated based on the received credentials. Alternatively or additionally, the credentials associated to the requesting users can be received from an authentication server (such as the authentication server 119 of FIG. 1A) based, at least in part, on generating a request for credentials to the authentication server. In one example, the authentication server can further verify the identity of the requesting users before the authentication tokens are generated. In step 325, the generated authentication token based, at least in part, on the credentials associated to the requesting users can be transmitted to the requested resource. Alternatively or additionally, the generated authentication token can be stored in the security information associated with the resource. Therefore, according to certain embodiment, these authentication tokens can be used for subsequent access requests from the users to grant access.

In one example, the authentication token can be based on PKI-like infrastructure and can include public key and/or certificate associated to the user. In one embodiment, the security information associated with the resource can include security policies such as, but not limited to, “Signed friend”, “Singed non-friend”, or “Signed blocked” policies, as discussed above. In one embodiment, the generation of authentication tokens based, at least in part, on public keys and/or certificates can be a one-time process, and depending on security policies that are in effect for the resource, the user can further access the resource without additional identification (e.g., in case of “Signed friend” policy).

Also, according to certain embodiments, the secure phonebook (such as the secure phonebook 111 and/or 113) can include authentication tokens (e.g., based on public keys and/or certificates) for one or more services. In one example, these authentication tokens can be pre-programmed in, for instance, the UE 101, such that the security policies for these services are based on “Signed services.” Therefore, advantageously eliminating current sign-in process with usernames and passwords.

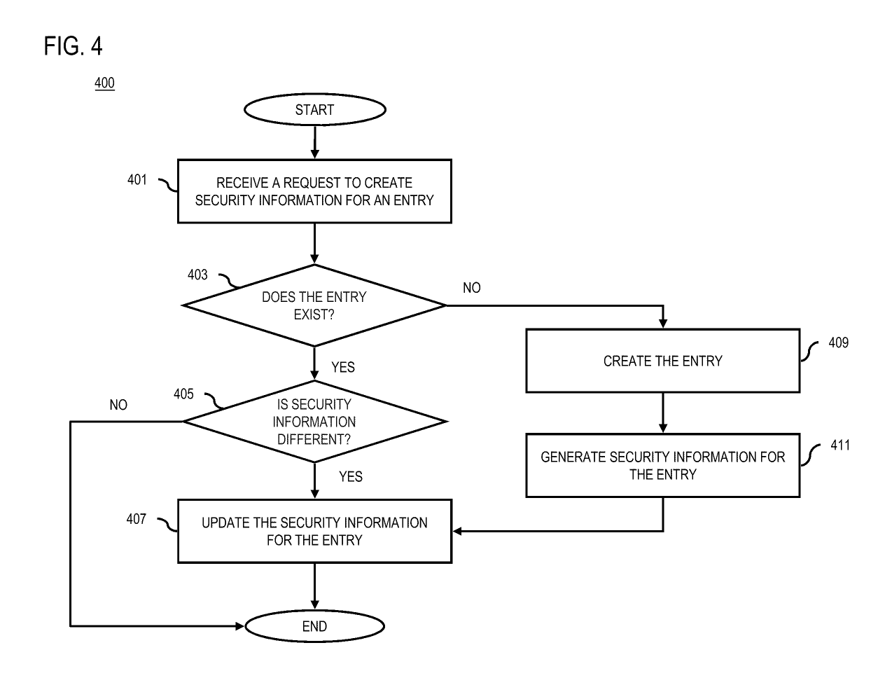

FIG. 4 is a flowchart of a process for creating entries in a secure phonebook, according to an embodiment. In one embodiment, the security manager 107 and/or the security management platform 109 of FIG. 1A performs the process 400. In the exemplary process 400, an entry of a secure phonebook, such as secure phonebooks 111 and/or 113, can be generated and/or updated. Also, it is noted that in certain embodiments, the secure phonebook 111 can be initially generated, for example, for each UE 101 by a service provider, by manufacturers, etc. In this way, the UE 101 may be preconfigured with a phonebook 111 containing entries associated with resources pre-approved or verified by the device manufacturer, service provider, content provider, network operator, or the like.

In step 401 of the process 400, a request to create an entry in the secure phonebook is received. In one example, the entry can include an identifier of a resource and security information (e.g., security context, security policy, etc.) associated with the identifier. According to certain embodiments, the request to create a secure phonebook entry can be initiated by a user, by a resource, etc. In one example, a user, consumer, and/or an owner of the UE 101 can initiate a request to enter new entries or update the entries of the secure phonebook. In another example, an application, a browser (e.g., using bookmarks), a script, an executable, operating system, application manager, package manager, etc., can initiate the request.

In one example, the browser 117, the class loader 133, the package manager 135, the application manager 137, or a combination thereof, can initiate the creation of an entry in the secure phonebook. In an example, the entry can be for a resource, such as a downloaded application and/or plug-in. The entry can include, identifier of the resource, the address where the resource resides, owner and/or author of it, security information and/or policy (e.g., execution privileges). In one example, default policies such as “Standard plug-in policy” and/or “Standard application policy” (as discussed earlier) can be defined for plug-ins and/or applications.

In step 403, it is determined whether the requested entry already exists in the secure phonebook. In one example, this determination can be performed by checking if the identifier determined in the request already exists in the secure phonebook. If it is determined that the entry is already available in the secure phonebook, in step 405, the security information determined in the received request can be checked against the security information that exists in the secure phonebook for the identifier. If the received security information is different, in step 407, the security information in the secure phonebook is updated.

However, if in step 403, it was determined that no entry exists for the received identifier, in steps 409 and 411 an entry can be created for the received identifier and security information associated with the identifier can be populated for that entry based on the received information.

The security manager 107 and/or the security management platform 109 along with the secure phonebook 111 and/or 113, can advantageously provide a uniform, secure, and trusted platform that be used by users, resources, applications, entities, etc., to manage, access, and/or use the security information they might need.

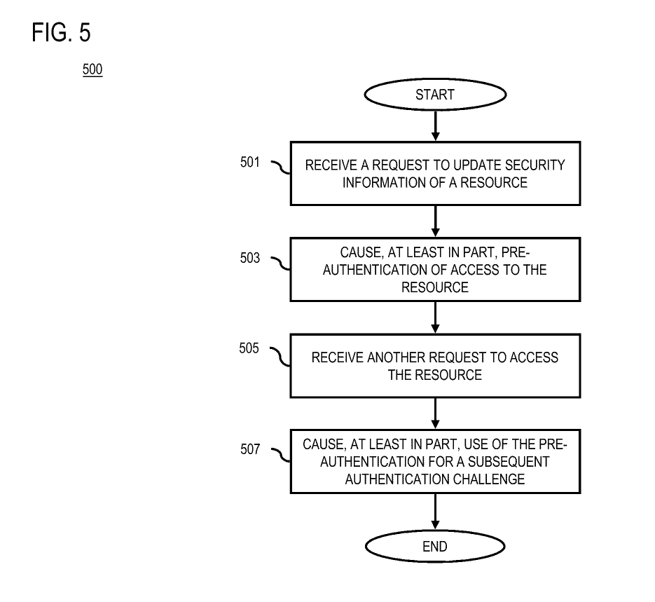

FIG. 5 is a flowchart of a process for managing security information for entries in a secure phonebook, according to an embodiment. In one embodiment, the security management platform 109 and/or the security manager 107 of FIG. 1A can perform the process 500. In certain embodiments, the process 500 can be used to manage security information (such as security context, security policy, etc.) associated to a resource. In one example, process 500 can be performed if a user of the UE 101 desires to extend access rights to a resource to more users, applications, etc.

In step 501, a request is received for managing the security information associated to a resource. In one example, the request can include an identifier of the resource that can be used to locate the security information. Further, the request can include new security information for the resource. In step 503, a pre-authentication process for access to the resource can be performed. In one example, the managing request can include a request from a user of the UE 101 to add new users and/or new applications to a list of allowable users and/or application to access the resource. In this example, the pre-authentication process can be performed to authenticate the new users and/or new applications based on, for example, their credentials. The pre-authentication process can be performed, in one example, in accordance with the authentication server 119 of FIG. 1A. When the pre-authentication process is performed, the security information of the resource can be updated. In one example, the security information is managed at the secure phonebook as a resource token. According to certain embodiments, the resource token can be signed with, for instance, a key and certificate of the user of UE 101, a key and certificate of a service provider server, etc. In step 505, a request can be received to access the resource. In step 507, the security information, such as the pre-authentication, of the resource can be used to authenticate the requester and gain access to the resource in case the requester has privileges to access. Therefore, process 500 advantageously expedites access to the resources without, for instance, having to communicate with the user of the UE 101 for each access request.

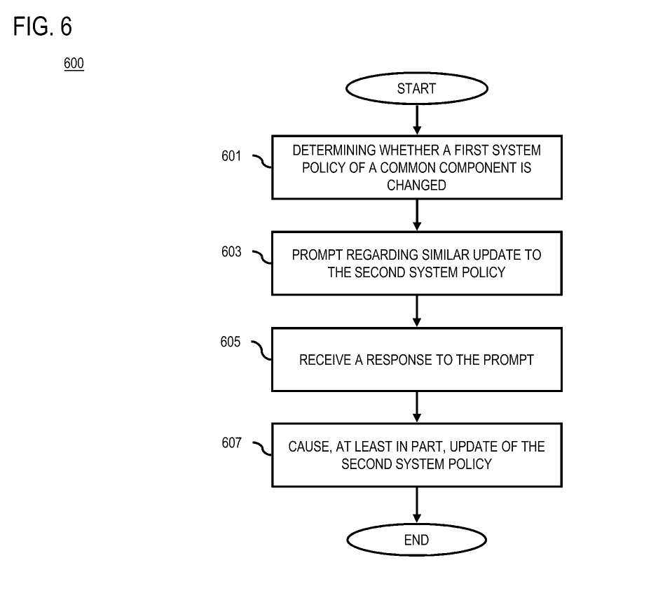

FIG. 6 is a flowchart of a process for managing security information for entries in a secure phonebook with common components, according to an embodiment. In one embodiment, the security management platform 109 and/or the security manager 107 of FIG. 1A can perform the process 600. In one example, process 600 is directed to inheritance of security policies of different resources that share one or more common components. In step 601, a determination is made if any changes are made to a first security policy, which includes a common component with a second security policy. If it is determined that the first security policy is changed and it is determined that there exist the second security policy that shares common component with the first policy, presentation of a prompt to, for instance, the user of the UE 101 of FIG. 1A, is initiated. In one example, this prompt is used to confirm with, for instance, the user, whether similar changes should be applied to the second security policy. In step 605, a response to the prompt is received. Based on the response, necessary changes are made to the second security policy in step 607.

According to certain embodiment, the process 600 can skip steps 603 and 605. In other words, if the first and the second security policies have one or more common components and a determination is made that one of the security policies has been changed, similar changes can be applied to the other security policy.

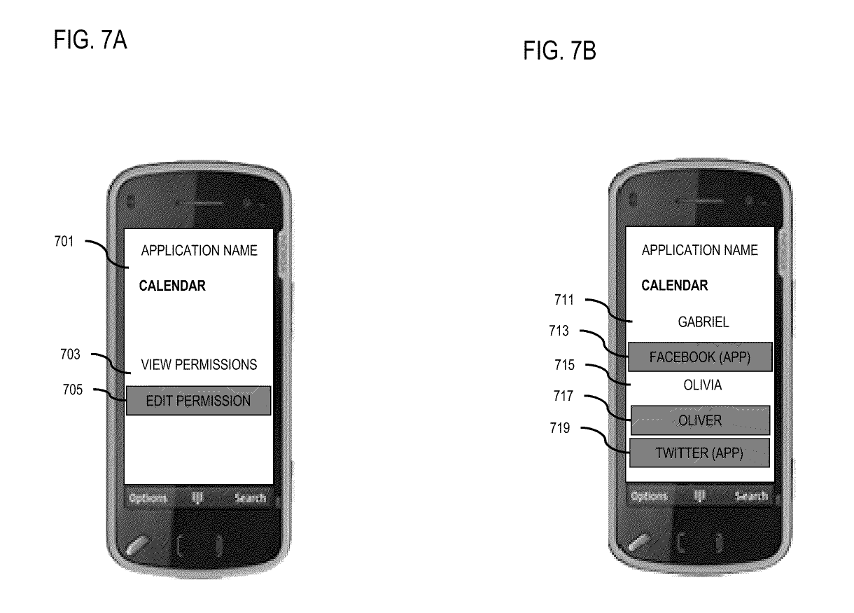

FIGS. 7A and 7B are diagrams of a graphical user interface for managing security information for entries in a secure phonebook, according to one embodiment. In one example, the user interface (UI) illustrated in FIGS. 7A and 7B can be controlled by the user interface module 201 of FIG. 2, and can be used as the interface between a user of the UE 101 and the security manager 107 (and/or 109) and/or the secure phonebook 111 (and/or 113) of FIG. 1.

According to one embodiment, the UI can present a text representation 701 illustrating an application that the user of the UE 101 intends to modify some information associated to it. In one embodiment, the application is associated with a resource token in the secure phonebook 111 and/or 113 of FIG. 1 that includes or represents security requirements, contexts, policies or combination thereof corresponding to the application. In this example, the user intends to modify access permission to a calendar application. Accordingly, the UI of FIG. 7A can include different options that can provide the user ability to add, delete, update, etc., for example, access information for the selected application (in this example, the calendar application). Continuing with this example, the UI can include the view permission option 703 and the edit option 705. If the user intends to modify the access permissions to the application calendar, the user can select the edit permission option 705. In this way, the user can modify the users, applications, entities, etc., that can access the calendar application.

According to certain embodiments, when the user chooses to edit permissions, the UI can present one or more entries of the secure phonebook 111 and/or 113. Therefore, the user can select the entries of the secure phonebook 111 and/or 113, which the user desires to grant access to the selected application. In this example, when the user selects the edit permission option 705, the UI of FIG. 7B can be presented, representing the entries 711 through 719 from the secure phonebook 111 and/or 113. According to this example, the user can select, for example, the applications Facebook and Twitter (713 and 719), and the user Oliver 717 to grant access to the user's calendar application. According to one example, the resource token associated to the selected application (e.g., the calendar application) can be updated with the new access permissions, can be signed and/or certified by the user, the UE 101, a service provider server, or a combination thereof, and can be stored at the secure phonebook 111 and/or 113. Therefore, future access to the application (e.g., the calendar application) by other users, applications, entities, etc., can be advantageously checked against access permissions of the resource token.

The processes described herein for providing a heterogeneous security management platform may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

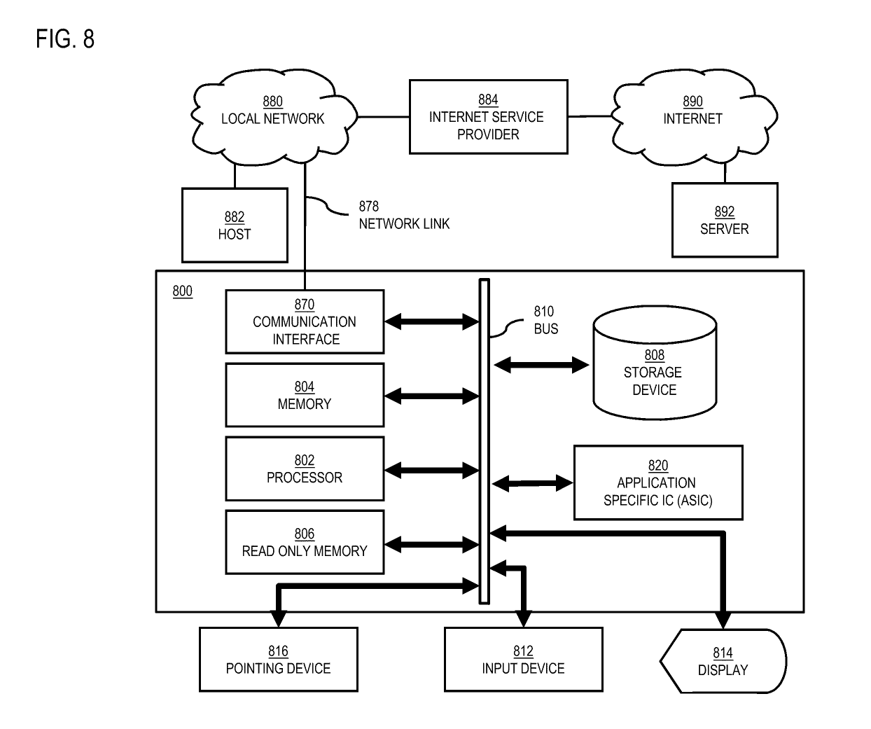

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide a security management platform as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing a security management platform.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing a security management platform. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing a security management platform. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing a security management platform, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing a security management platform to the UE 101.

The term “computer-readable medium” as used herein to refer to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to provide a security management platform as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of providing a security management platform.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a security management platform. The memory 905 also stores the data associated with or generated by the execution of the inventive steps.

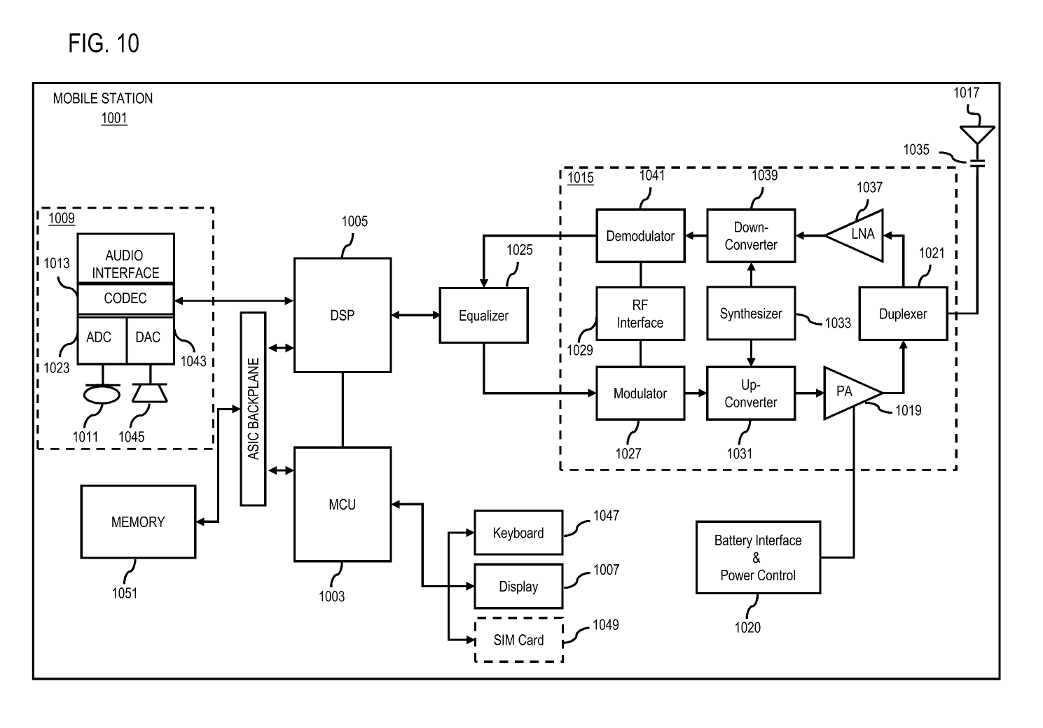

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of providing a security management platform. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing a security management platform. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide a security management platform. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
acting on a request that references, at least in part, a resource, the resource associated with a network identifier;
determining whether the network identifier is listed in a secure phonebook, the secure phonebook associating the network identifier with, at least in part, a security context; and
providing the security context for one or more applications, scripts, executables, or combination thereof to determine access privileges to the resource based, at least in part, on the determination.

2. A method of claim 1, wherein the secure phonebook further associates the network identifier with one or more system policies, the method further comprising:
causing, at least in part, enforcement of the system policies for access to the resource.

3. A method of claim 2, further comprising:
causing, at least in part, pre-authentication of access to the resource according to at least one of the system policies;
receiving another request to access the resource; and
causing, at least in part, use of the pre-authentication for a subsequent authentication challenge associated with the resource.

4. A method of claim 2, wherein the resource shares at least one common component with another resource, the method further comprising:
determining whether a first system policy of the at least one common component has been changed with respect to the resource;
causing, at least in part, presentation of a prompt requesting an update of a second system policy of the at least one common component with respect to the another resource based, at least in part, on the determination with respect to the first system policy;
receiving a response to the prompt; and
causing, at least in part, the update of the second system policy of the at least one common component based, at least in part, on the response.

5. A method of claim 1, further comprising:
receiving another request to grant access to the resource to one or more users;
generating one or more authentication tokens based at least in part on unique credentials associated with the respective users; and
causing, at least in part, transmission of the tokens to the resource,
wherein the resource uses the tokens to automatically authenticate access to the resource by the users.

6. A method of claim 1, wherein the network identifier is not listed in the secure phonebook, the method further comprising:
providing a default security context for the applications, scripts, executables or combination thereof to access the resource.

7. A method of claim 1, wherein the resource is part of a network whose components are associated with a respective unique network identifier, the network identifier including, at least in part, a fully qualified domain name.

8. A method of claim 1, wherein the security context is unique to the resource.

9. An apparatus comprising:
at least one processor; and
at least one memory including computer program code,
the at least one memory and the computer program code configured to, with the at least one processor, cause the apparatus to perform at least the following,
act on a request that references, at least in part, a resource, the resource associated with a network identifier;
determine whether the network identifier is listed in a secure phonebook, the secure phonebook associating the network identifier with, at least in part, a security context; and
provide the security context for one or more applications, scripts, executables, or combination thereof to determine access privileges to the resource based, at least in part, on the determination.

10. An apparatus of claim 9, wherein the secure phonebook further associates the network identifier with one or more system policies, and wherein the apparatus is further caused to:
cause, at least in part, enforcement of the system policies for access to the resource.

11. An apparatus of claim 10, wherein the apparatus is further caused to:
cause, at least in part, pre-authentication of access to the resource according to at least one of the system policies;
receive another request to access the resource; and
cause, at least in part, use of the pre-authentication for a subsequent authentication challenge associated with the resource.

12. An apparatus of claim 10, wherein the resource shares at least one common component with another resource, and wherein the apparatus is further caused to:
determine whether a first system policy of the at least one common component has been changed with respect to the resource;
cause, at least in part, presentation of a prompt requesting an update of a second system policy of the at least one common component with respect to the another resource based, at least in part, on the determination with respect to the first system policy;
receive a response to the prompt; and
cause, at least in part, the update of the second system policy of the at least one common component based, at least in part, on the response.

13. An apparatus of claim 9, wherein the apparatus is further caused to:
receive another request to grant access to the resource to one or more users;
generate one or more authentication tokens based at least in part on unique credentials associated with the respective users; and
cause, at least in part, transmission of the tokens to the resource,
wherein the resource uses the tokens to automatically authenticate access to the resource by the users.

14. An apparatus of claim 9, wherein the network identifier is not listed in the secure phonebook, and wherein the apparatus is further caused to:
provide a default security context for the applications, scripts, executables or combination thereof to access the resource.

15. An apparatus of claim 9, wherein the resource is part of a network whose components are associated with a respective unique network identifier, the network identifier including, at least in part, a fully qualified domain name.

16. An apparatus of claim 9, wherein the security context is unique to the resource.

17. A computer-readable storage medium carrying one or more sequences of one or more instructions which, when executed by one or more processors, cause an apparatus to at least perform the following steps:
acting on a request that references, at least in part, a resource, the resource associated with a network identifier;
determining whether the network identifier is listed in a secure phonebook, the secure phonebook associating the network identifier with, at least in part, a security context; and
providing the security context for one or more applications, scripts, executables, or combination thereof to determine access privileges to the resource based, at least in part, on the determination.

18. A computer-readable storage medium of claim 17, wherein the secure phonebook further associates the network identifier with one or more system policies, and wherein the apparatus is caused to further perform:
causing, at least in part, enforcement of the system policies for access to the resource.

19. A computer-readable storage medium of claim 18, wherein the apparatus is caused to further perform:
causing, at least in part, pre-authentication of access to the resource according to at least one of the system policies;
receiving another request to access the resource; and
causing, at least in part, use of the pre-authentication for a subsequent authentication challenge associated with the resource.

20. A computer-readable storage medium of claim 17, wherein the apparatus is caused to further perform:
receiving another request to grant access to the resource to one or more users;
generating one or more authentication tokens based at least in part on unique credentials associated with the respective users; and
causing, at least in part, transmission of the tokens to the resource,
wherein the resource uses the tokens to automatically authenticate access to the resource by the users.
